(19) United States
(12) Patent Application Publication
(10) Pub. No.: US 2019/0149419 A1
(43) Pub. Date: May 16, 2019

(54) INFORMATION PROCESSING DEVICE AND INFORMATION PROCESSING METHOD

(71) Applicant: FUJITSU LIMITED, Kawasaki-shi (JP)

(72) Inventor: Toshiaki SAEKI, Kawasaki (JP)

(73) Assignee: FUJITSU LIMITED, Kawasaki-shi (JP)

(21) Appl. No.: 16/190,318

(22) Filed: Nov. 14, 2018

(30) Foreign Application Priority Data
Nov. 15, 2017 (JP) 2017-219779

(51) Int. Cl. H04L 12/24; H04L 12/751; H04L 12/707

(52) U.S. Cl. CPC H04L 41/0893; H04L 45/24; H04L 45/02; H04L 41/145

(57) ABSTRACT

An information processing device includes a processor that extracts at least one hub node from a network. The at least one hub node is connected to a predetermined number of nodes or more. The processor classifies nodes connected to each of the at least one hub node into groups. The processor stores group information for each of the groups in association with identification of the group. The group information includes identification of each member node of the group and identification of each adjacent node connected to each member node. The processor generates, in graph traversal of the network, a route by identifying each adjacent node for each group by using the identification of the group as a key from the group information. The processor generates a plurality of routes by expanding a first group on the route generated by the graph traversal, based on group information of the first group.

### CROSS-REFERENCE TO RELATED APPLICATION

This application is based upon and claims the benefit of priority of the prior Japanese Patent Application No. 2017-219779, filed on Nov. 15, 2017, the entire contents of which are incorporated herein by reference.

### FIELD

The embodiments discussed herein are related to an information processing device and an information processing method.

### BACKGROUND

A complex network is a network in which a connection pattern between vertices (or nodes) has neither exact regularity nor real randomness. FIG. 1 is a diagram illustrating an example of a complex network. In FIG. 1, a circle indicates a vertex and a line segment between vertices indicates an edge connecting the vertices at the both ends of the edge. Among huge and complex networks in the real world, such as, for example, a social network, a knowledge graph, or the like, there are networks that have properties of complex networks.

It is known that a complex network is a scale-free network. The scale-free network is a network in which a degree distribution follows a power law and the degree is the number of edges of vertices. In the scale-free network, there are only a few vertices with a very large degree (for example, about 1%), which are called hubs or hub nodes. On the other hand, many vertices (for example, about 50%) have only a few edges, that is, one or two edges. In some cases, a total number of edges of hubs reaches almost a half of the number of all of edges in the complex network and, in such a case, a vertex which is to be reached next after a certain vertex is a hub with a probability of 50%.

Related techniques are disclosed in, for example, Japanese Laid-open Patent Publication No. 2016-189214, Japanese Laid-open Patent Publication No. 02-253478, and Japanese National Publication of International Patent Application No. 2013-519140.

Graph traversal is a type of graph processing and processing of following vertices in a graph for the purpose of route search or the like. Because of the above-described properties related to hubs, there is a high probability that, when graph traversal is executed on a complex network, a route goes through a hub. If the route goes through a hub, a problem arises in which the number of times of random access to (specifically, random read from) a storage device increases due to route combination explosion and therefore processing time increases. As described above, in some cases, depending on the complex network, almost half of edges are coupled to the hub, and therefore, particularly, a pattern in which a plurality of routes extending from a first hub goes through a second hub tends to cause increase in the processing time. A known technique related to graph processing is not appropriate as a solution to the above-described problem.

### SUMMARY

According to an aspect of the present invention, provided is an information processing device including a memory and a processor coupled to the memory. The memory is configured to store node information regarding a plurality of nodes included in a network. The processor is configured to extract at least one hub node from the network based on the node information stored in the memory. The at least one hub node is a node connected to a predetermined number of nodes or more in the network. The processor is configured to classify nodes connected to each of the at least one hub node into groups. The processor is configured to store group information for each of the groups in the memory in association with identification information of the group. The group information includes identification information of each member node that belongs to the group and identification information of each adjacent node connected to each member node. The processor is configured to generate, in graph traversal of the network, a route by identifying each adjacent node for each group by using the identification information of the group as a key from the group information stored in the memory. The processor is configured to generate a plurality of routes by expanding a first group on the route generated by the graph traversal, based on group information of the first group.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a complex network;

FIG. 2 is a functional block diagram of an information processing device;

FIG. 3 is a diagram illustrating grouping in an embodiment;

FIG. 4 is a diagram illustrating grouping in the embodiment;

FIG. 5 is a diagram illustrating grouping in the embodiment;

FIG. 6 is a diagram illustrating grouping in the embodiment;

FIG. 7 is a table illustrating an example of data stored in a first KVS;

FIG. 8A is a table illustrating an example of data stored in a second KVS;

FIG. 8B is a table illustrating an example of data stored in the second KVS;

FIG. 9 is a flowchart illustrating a processing flow of processing that is executed by a grouping unit;

FIG. 10 is a flowchart illustrating a processing flow of processing that is executed by a traversal processing unit in a first embodiment;

FIG. 11 is a flowchart illustrating a processing flow of processing that is executed by the traversal processing unit in the first embodiment;

FIG. 12 is a table illustrating graph traversal of the first embodiment;

FIG. 13 is a view illustrating graph traversal of the first embodiment;

FIG. 14 is a table illustrating graph traversal of the first embodiment;

FIG. 15 is a view illustrating graph traversal of the first embodiment;

FIG. 16 is a view illustrating graph traversal of the first embodiment;

FIG. 17 is a view illustrating graph traversal of the first embodiment;

FIG. 18 is a view illustrating graph traversal of the first embodiment;

FIG. 19 is a diagram illustrating grouping in the first embodiment;

FIG. 20 is a diagram illustrating grouping in the first embodiment;

FIG. 21 is a flowchart illustrating a processing flow of processing that is executed by a traversal processing unit in a second embodiment;

FIG. 22 is a flowchart illustrating a processing flow of processing that is executed by the traversal processing unit in the second embodiment;

FIG. 23 is a flowchart illustrating a processing flow of processing that is executed by the traversal processing unit in the second embodiment;

FIG. 24 is a flowchart illustrating a processing flow of processing that is executed by the traversal processing unit in the second embodiment;

FIG. 25 is a flowchart illustrating a processing flow of processing that is executed by the traversal processing unit in the second embodiment;

FIG. 26 is a flowchart illustrating a processing flow of processing that is executed in normal traversal processing;

FIG. 27 is a flowchart illustrating a processing flow of processing that is executed in normal traversal processing; and

FIG. 28 is a functional block diagram of a computer.

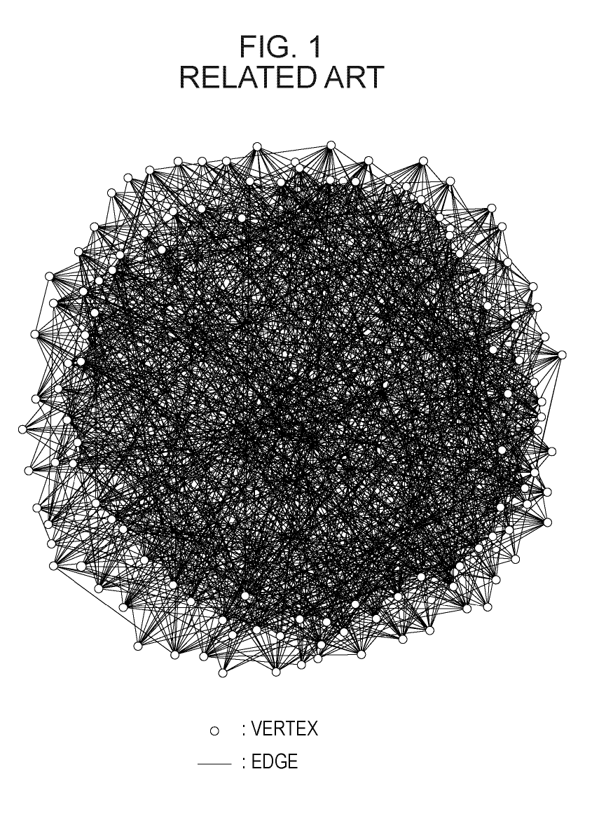

### DESCRIPTION OF EMBODIMENTS

### First Embodiment

An information processing device 1 according to this embodiment is a device, such as a personal computer, a server, or the like, which executes graph processing for a complex network. The information processing device 1 receives a query of graph traversal (which will be hereinafter referred to as a traversal query) via a network, such as a local area network (LAN), the Internet, or the like, executes graph traversal in accordance with the received traversal query, and outputs a result of graph traversal.

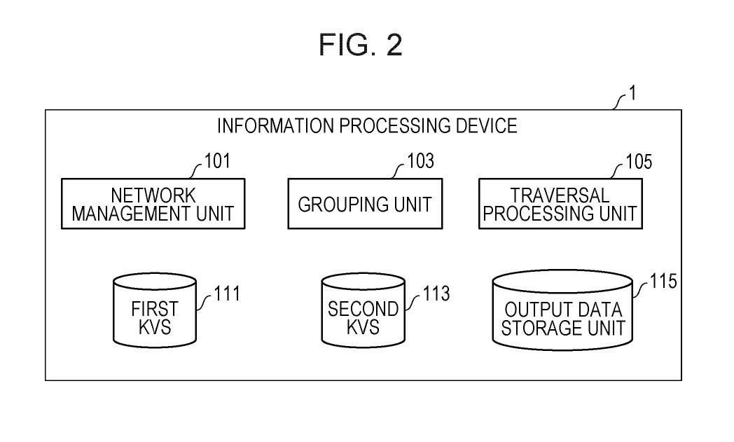

FIG. 2 is a functional block diagram of the information processing device 1. The information processing device 1 includes a network management unit 101, a grouping unit 103, a traversal processing unit 105, a first key-value store (KVS) 111, a second KVS 113, and an output data storage unit 115.

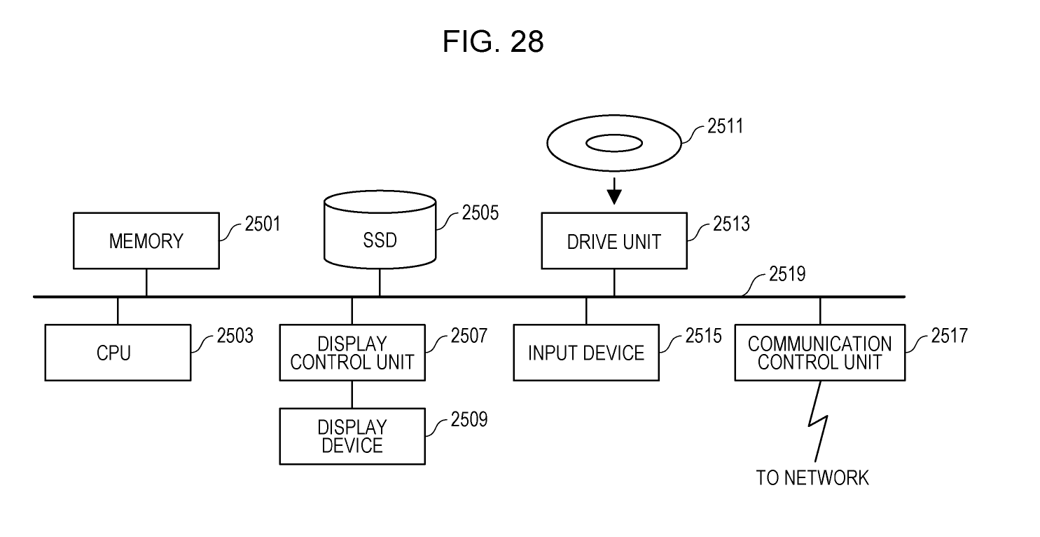

A program stored, for example, in a solid state drive (SSD) 2505 in FIG. 28 is read out by a memory 2501 and executed by a central processing unit (CPU) 2503, and thereby, the network management unit 101, the grouping unit 103, and the traversal processing unit 105 are realized. The first KVS 111, the second KVS 113, and the output data storage unit 115 are provided, for example, in the SSD 2505.

The network management unit 101 manages information of a vertex that is adjacent to each vertex in the complex network in the first KVS 111. When a topology of the complex network is changed, the network management unit 101 updates data stored in the first KVS 111. Note that “adjacent” means that a vertex is coupled to another vertex by one hop. A vertex that is adjacent to a certain vertex or a group will be also called “adjacent vertex” below. Also, a group that is adjacent to a certain vertex will be also called “adjacent group”.

The grouping unit 103 extracts a hub, based on the data stored in the first KVS 111, and classifies adjacent vertices of the extracted hub into groups. The grouping unit 103 stores a result of grouping in the second KVS 113.

The traversal processing unit 105 executes graph traversal on the complex network, based on the data stored in the first KVS 111 and data stored in the second KVS 113, and stores a result of graph traversal in the output data storage unit 115.

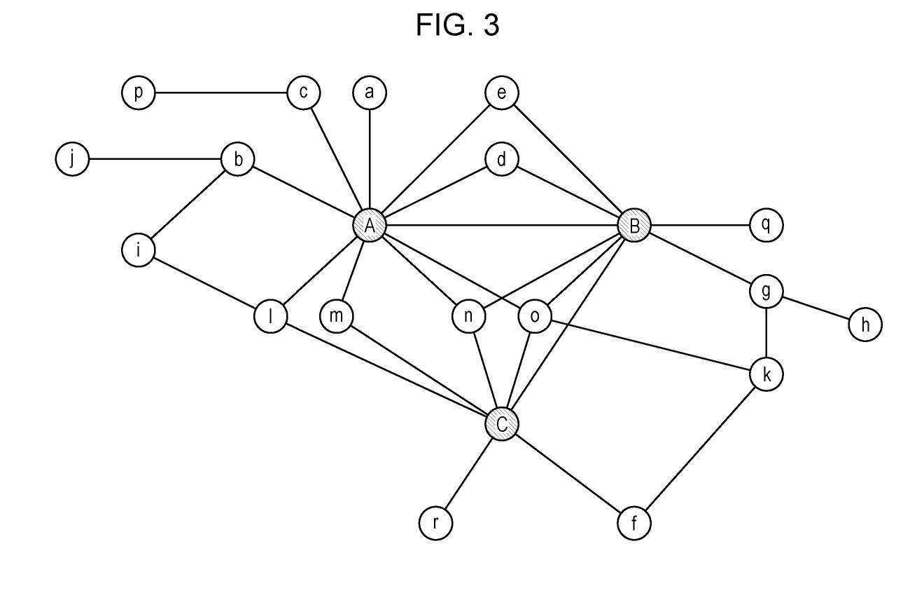

An outline of grouping in this embodiment will be hereinafter described. As an example, as illustrated in FIG. 3, a complex network will be considered. In FIG. 3, a non-directed graph is illustrated, a circle indicates a vertex, and a line segment between vertexes indicates an edge. In FIG. 3, a vertex with a degree of 5 or more is a hub, and therefore, a vertex A, a vertex B, and a vertex C are hubs. The vertex A, the vertex B, and the vertex C are hatched. Note that, in many cases, an actual complex network is more complex than a network illustrated in FIG. 3 but, in order to simplify description, a simple example is used herein.

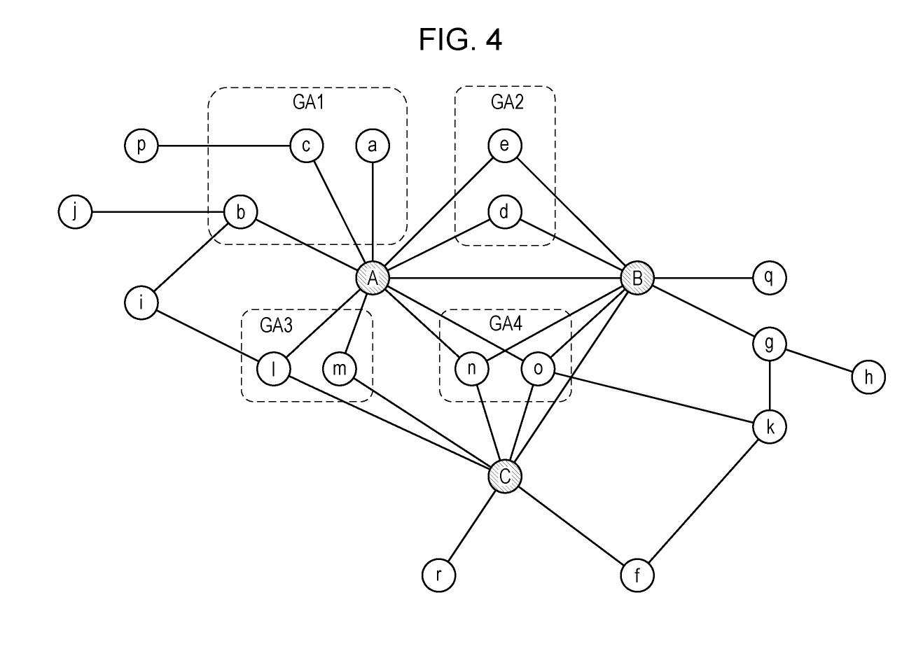

FIG. 4 is a diagram illustrating a result of classifying adjacent vertices of a hub A into groups. The adjacent vertices of the hub A are a vertex a, a vertex b, a vertex c, a vertex d, a vertex e, a vertex I, a vertex m, a vertex n, a vertex o, and the vertex B that is a hub. In this embodiment, grouping is executed such that (1) a condition in which vertices to which hubs in the same combination are adjacent belong to the same group and (2) a condition in which hubs do not belong to a group are satisfied. When vertices are classified into groups in accordance with these rules, the grouping is performed as illustrated in FIG. 4. The vertex a, the vertex b, and the vertex c are adjacent to the hub A, and therefore, belong to a group GA1, the vertex d and the vertex e are adjacent to the hub A and the hub B, and therefore, belong to a group GA2, the vertex I and the vertex m are adjacent to the hub A and the hub C, and therefore, belong to a group GA3, and the vertex n and the vertex o are adjacent to the hub A, the hub B, and the hub C, and therefore, belong to a group GA4. The vertex B is a hub and does not belong to any group.

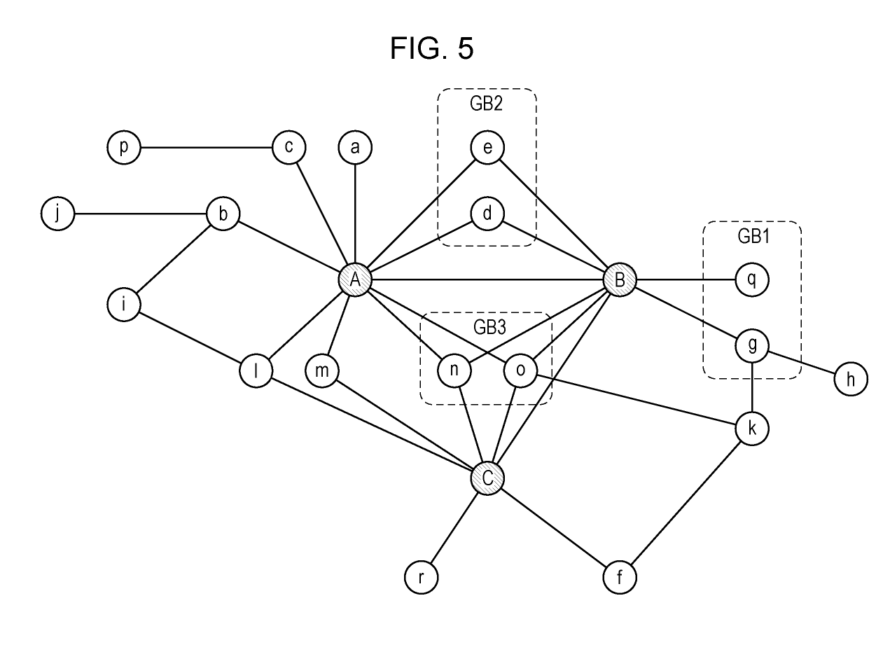

FIG. 5 is a diagram illustrating a result of classifying adjacent vertices of a hub B into groups. The adjacent vertices of the hub B are a vertex A that is a hub, a vertex C that is a hub, a vertex g, a vertex q, a vertex d, a vertex e, a vertex n, and a vertex o. When vertices are classified into groups in accordance with the rules described above, the grouping is performed as illustrated in FIG. 5. The vertex g and the vertex q are adjacent to the hub B, and therefore, belong to a group GB1, the vertex d and the vertex e are adjacent to the hub A and the hub B, and therefore, belong to a group GB2, and the vertex n and the vertex o are adjacent to the hub A, the hub B, and the hub C, and therefore, belong to a group GB3. The vertex A that is a hub and the vertex C that is a hub do not belong to any group.

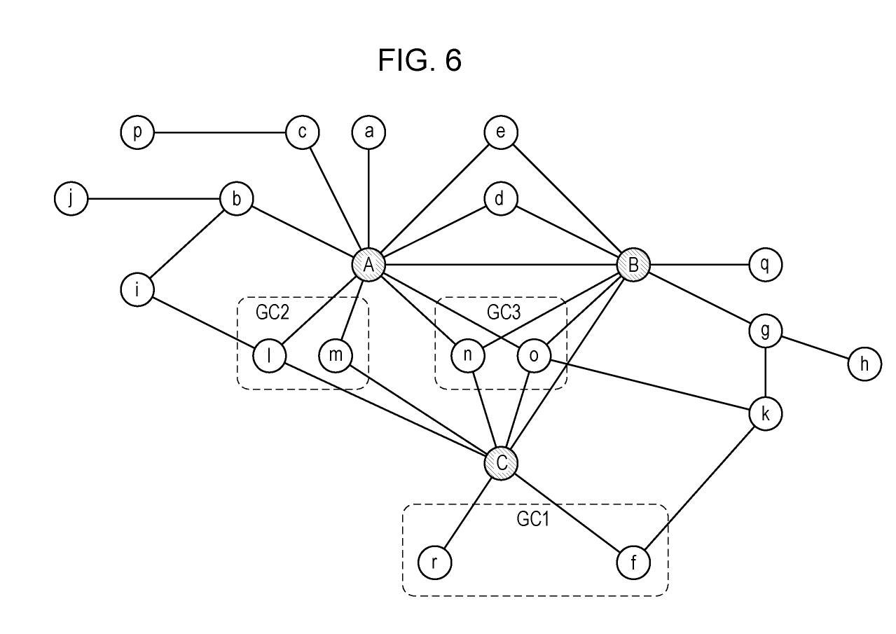

FIG. 6 is a diagram illustrating a result of classifying adjacent vertices of a hub C into groups. The adjacent vertices of the hub C are a vertex B that is a hub, a vertex f, a vertex r, a vertex I, a vertex m, a vertex n, and a vertex o. When vertices are classified into groups in accordance with the rules described above, the grouping is performed as illustrated in FIG. 6. The vertex f and the vertex r are adjacent to the hub C, and therefore, belong to a group GC1, the vertex I and the vertex m are adjacent to the hub A and the hub C, and therefore, belong to a group GC2, and the vertex n and the vertex o are adjacent to the hub A, the hub B, and the hub C, and therefore, belong to a group GC3. The vertex B that is a hub does not belong to any group.

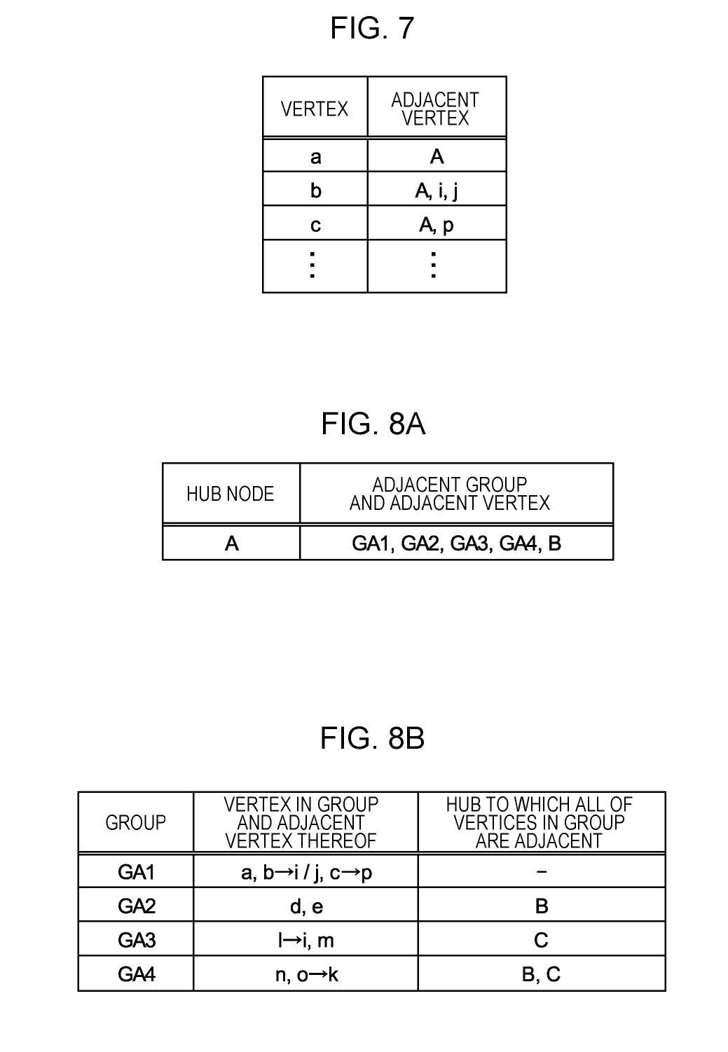

FIG. 7 is a table illustrating an example of data stored in the first KVS 111. In the example of FIG. 7, identification information (key) of a vertex and identification information (value) of an adjacent vertex of the vertex are stored. Entries are generated for all of vertices (including hubs) in the complex network.

FIG. 8A and FIG. 8B are diagrams each illustrating an example of data stored in the second KVS 113. In FIG. 8A and FIG. 8B, an example of data that is stored for the hub A illustrated in FIG. 4 is illustrated. In the example of FIG. 8A, identification information (key) of a hub, identification information of adjacent groups of the hub, and identification information (value) of adjacent vertices of the hub are stored. In the example of FIG. 8B, identification information (key) of a group, identification information of vertices in the group, and identification information (value) of hubs to which all of vertices in the group are adjacent are stored.

Note that the data illustrated in FIG. 8A and FIG. 8B are generated for all of hubs.

Next, processing that is executed by the information processing device 1 will be described in detail.

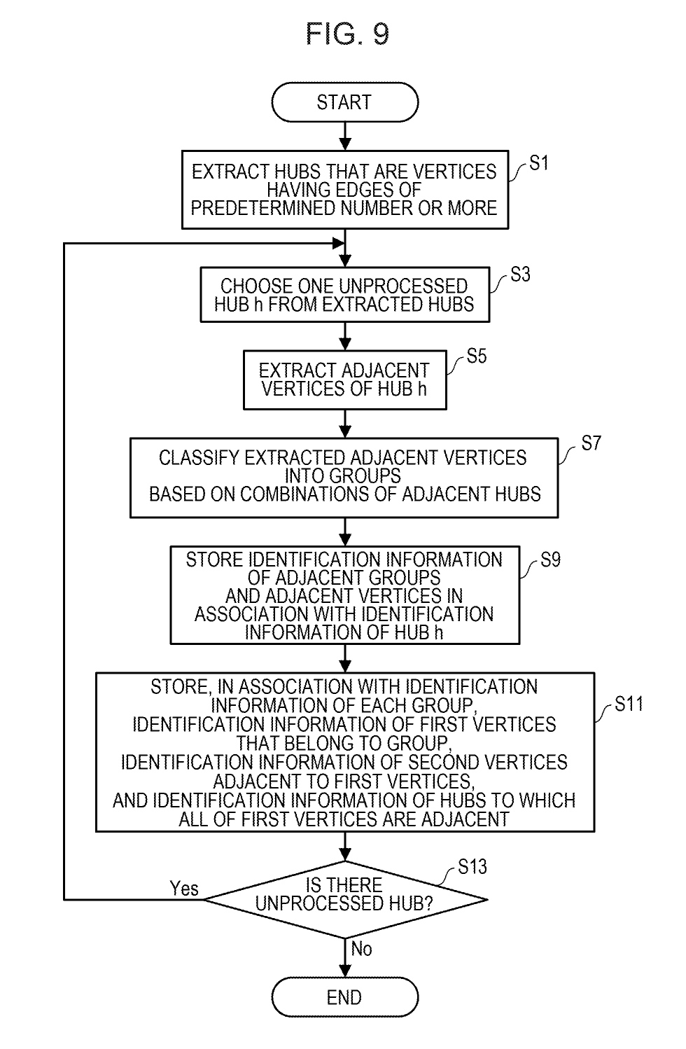

FIG. 9 is a flowchart illustrating a processing flow of processing that is executed by the grouping unit 103 of the information processing device 1. This processing is executed, for example, when data stored in the first KVS 111 is updated or in accordance with an instruction from a user.

The grouping unit 103 extracts hubs that are vertices each having edges of a predetermined number or more from a complex network, based on data stored in the first KVS 111 (Step S1 in FIG. 9).

The predetermined number in Step S1 is, for example, (1) a number that is determined, based on time taken to perform one random access to the SSD 2505 and processing time allowable for each one of vertices, or (2) the number of edges of a vertex the number of edges of which is the Nth (N is a natural number) largest among vertices in the complex network. For (1), for example, when the time taken to perform one random access is 10 microseconds and the processing time allowable for each one of vertices is 1 seconds (=1000000 microseconds), 100000 (=1000000/10) is the predetermined number. For (2), for example, when N is 13 and the number of edges of a 13^{th} vertex is 5000000, the predetermined number is 5000000. However, some other number than (1) and (2) may be the predetermined number.

The grouping unit 103 chooses one unprocessed hub from hubs extracted in Step S1 (Step S3). A hub that has been chosen in Step S3 will be hereinafter called a hub h.

The grouping unit 103 extracts adjacent vertices that are associated with the hub h from the first KVS 111 (Step S5).

The grouping unit 103 classifies adjacent vertices that have been extracted in Step S5 into groups, based on combinations of hubs that are adjacent to the adjacent vertices (Step S7). A method for grouping is as has been described with reference to FIG. 3 to FIG. 6.

The grouping unit 103 stores identification information of the adjacent groups and identification information of the adjacent vertices in association with identification information of the hub h in the second KVS 113 (Step S9).

The grouping unit 103 stores, in association with identification information of each adjacent group of the hub h, identification information of first vertices that belong to the group, identification information of second vertices adjacent to the first vertices, and identification information of a hub to which all of the first vertices are adjacent in the second KVS 113 (Step S11).

The grouping unit 103 determines whether or not there is an unprocessed hub among the hubs that have been extracted in Step S1 (Step S13).

If there is an unprocessed hub (YES route in Step S13), the process returns to Step S3. On the other hand, if there is not an unprocessed hub (NO route in Step S13), the process ends.

If the above-described processing is executed, it is enabled to prepare the data of the second KVS 113 which is used in graph traversal of this embodiment.

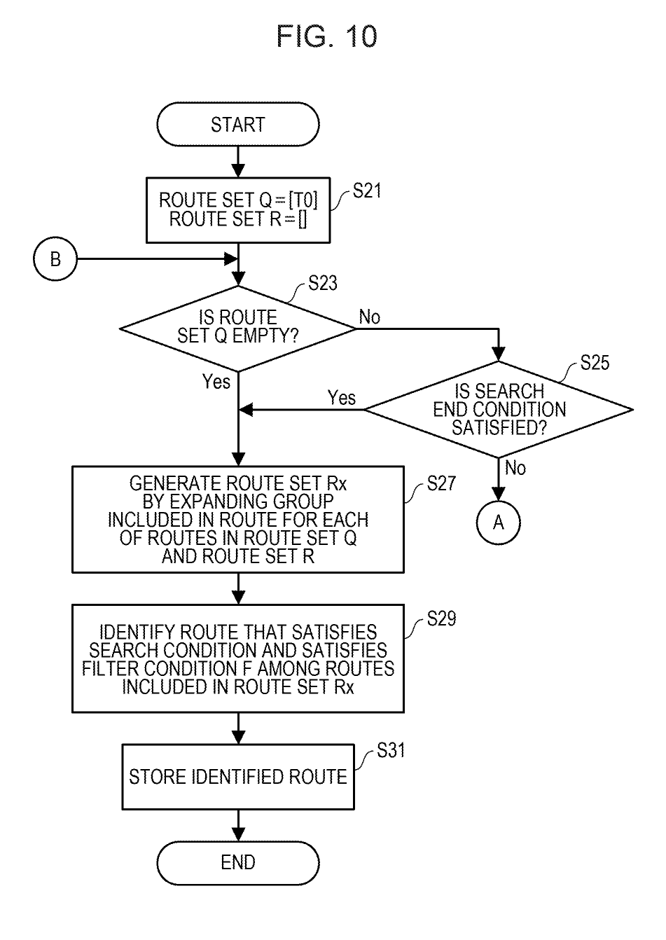

FIG. 10 is a flowchart illustrating a processing flow of processing that is executed by the traversal processing unit 105 in the first embodiment. This processing is executed when a traversal query is received or is accepted.

The traversal processing unit 105 executes initialization for traversal processing. Specifically, the traversal processing unit 105 sets a route set Q to Q=[T0] and a route set R to R=[ ] (Step S21 in FIG. 10).

In this embodiment, a route of graph traversal is expressed by a list. For example, when the vertex a, the vertex b, and the vertex c are searched in this order, a route is expressed as [a, b, c]. Q is a queue that is temporarily used and R is a queue that is used for storing a result. Q and R are stored, for example, in the memory 2501. Also, it is assumed that a vertex that is a starting point of graph traversal is n0. A route formed of only n0 is T0. That is, T0=[n0].

The traversal processing unit 105 determines whether or not the route set Q is empty (Step S23).

If the route set Q is empty (YES route in Step S23), the process proceeds to Step S27. On the other hand, if the route set Q is not empty (NO route in Step S23), the traversal processing unit 105 determines whether or not a search end condition is satisfied (Step S25). The search end condition is included in a traversal query and is a condition in which routes of a predetermined number or more have been found, a condition in which the number of hops of graph traversal has exceeded a predetermined threshold, or the like.

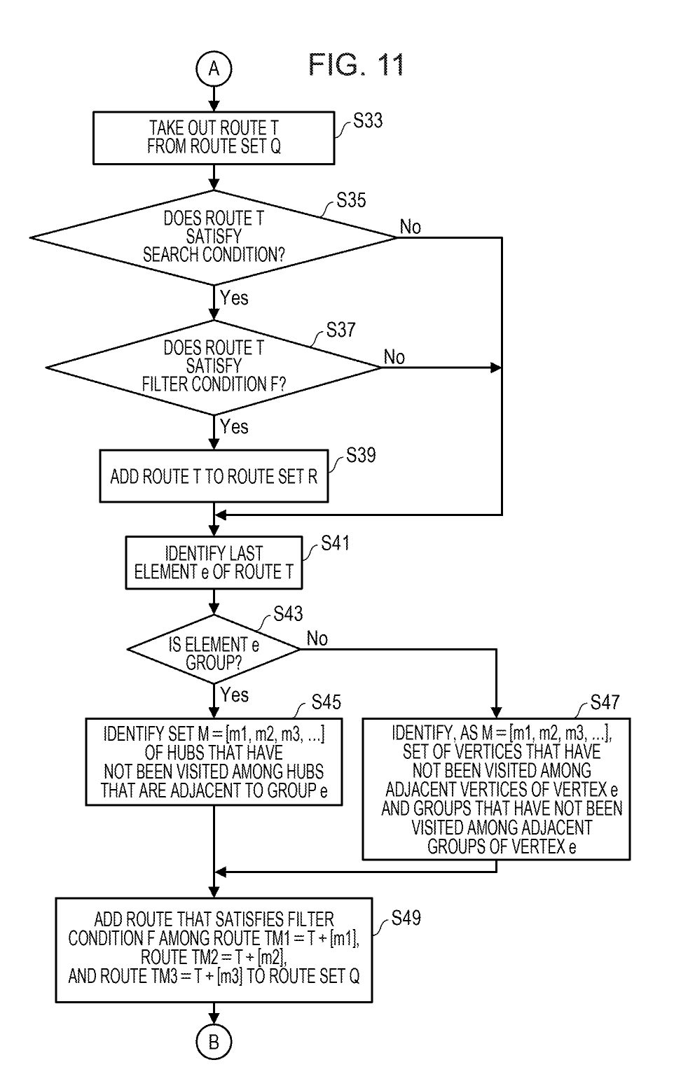

If the search end condition is not satisfied (NO route in Step S25), the process proceeds to processing in Step S33 in FIG. 11.

Moving to description of FIG. 11, the traversal processing unit 105 takes out one of routes in the route set Q (Step S33 in FIG. 11). A route that has been taken out in Step S33 will be hereinafter called a route T.

The traversal processing unit 105 determines whether or not the route T satisfies a search condition (Step S35). At the time of processing of Step S35, a group is not expanded, and therefore, there is a probability that a group is included in the route T. However, in some cases, even when a group is included in the route T, it is possible to determine that the route T evidently does not satisfy the search condition and, in such a case, the route T is excluded from options. Note that the search condition is included in a traversal query and is, for example, a condition in which a search target is a route in which a vertex a is a starting point and a vertex k is an end point or the like.

If the route T does not satisfy the search condition (NO route in Step S35), the process proceeds to Step S41.

On the other hand, if the route T satisfies the search condition (YES route in Step S35), the traversal processing unit 105 determines whether or not the route T satisfies a filter condition F (Step S37). At the time of processing of Step S37, a group is not expanded, and therefore, there is a probability that a group is included in the route T. However, in some cases, even when a group is included in the route T, it is possible to determine that the route T evidently does not satisfy the filter condition F and, in such a case, the route T is excluded from options. The filter condition F is included in the traversal query and is, for example, a condition in which the number of hops is a predetermined number or less, a condition in which a route goes through a certain vertex, or the like.

If the route T does not satisfy the filter condition F (NO route in Step S37), the process proceeds to Step S41. On the other hand, if the route T satisfies the filter condition F (YES route in Step S37), the traversal processing unit 105 adds the route T to the route set R (Step S39).

The traversal processing unit 105 identifies a last element e of the route T (Step S41). The element e is a vertex or a group. For example, if the route T is [A, B, c], the element e that is identified in Step S41 is a vertex c.

The traversal processing unit 105 determines whether or not the element e is a group (Step S43).

If the element e is a group (YES route in Step S43), the traversal processing unit 105 identifies a set M=[m1, m2, m3, . . . ] of hubs that have not been visited among hubs that are adjacent to a group e (Step S45). Then, the process proceeds to Step S49. A hub that has not been visited herein means a hub that is not included in the route T. Similar applies to description below.

As has been described above, vertices that belong to the same group are coupled to the same hub. In Step S45, hubs that are adjacent to vertices in a group are collectively identified by one random access to the SSD 2505, and therefore, random access may not be performed for each vertex. Thus, the number of times of random access may be reduced and the time taken to perform graph traversal may be reduced.

On the other hand, if the element e is not a group (NO route in Step S43), the traversal processing unit 105 executes the following processing. Specifically, the traversal processing unit 105 identifies, as M=[m1, m2, m3, . . . ], an adjacent vertex that has not been visited among adjacent vertices of a vertex e and a set of groups that have not been visited among adjacent groups of the vertex e (Step S47).

The traversal processing unit 105 generates a route TM1=T+[m1], a route TM2=T+[m2], a route TM3=T+[m3], . . . . Then, the traversal processing unit 105 adds a route that satisfies the filter condition F, among the route TM1=T+[m1], the route TM2=[m2], the route TM3=T+[m3], . . . , to the route set Q (Step S49). Then, the process returns to Step S23 in FIG. 10.

Returning to description of FIG. 10, if the search end condition is satisfied (YES route in Step S25), the traversal processing unit 105 generates a route set Rx by expanding, for each of routes in the route set Q and routes of the route set R, a group included in the route using data stored in the second KVS 113 (Step S27). For example, if the route is [a, A, GA2] and a vertex d and a vertex e are included in a group GA2, a route [a, A, d] and a route [a, A, e] are generated by expansion of the group. In this case, if the same vertex is visited twice or more due to expansion, the route is removed. For example, when a route [a, A, o, C, o] is generated by expansion, a vertex o is visited twice, and therefore, the route [a, A, o, C, o] is removed.

The traversal processing unit 105 identifies a route that satisfies the search condition and satisfies the filter condition F among routes included in the route set Rx (Step S29).

The traversal processing unit 105 stores information (for example, information in which identification information of a vertex included in a route is arranged in order) of a route that has been identified in Step S29 in the output data storage unit 115 (Step S31). Then, the process ends. Note that the traversal processing unit 105 may be configured to output information of the route stored in the output data storage unit 115 (for example, display the information on a display unit or transmit the information to a transmission source of a traversal query).

Normal graph traversal has a feature that the number of vertices that are searched and the number of times of random access substantially match. In contrast, in the method of this embodiment, vertices are classified into groups, based on a hub and one random access is executed on a plurality of vertices. Thus, even when a route goes through a hub, it is possible to restrain increase of the processing time caused by increase of the number of times of random access. Depending on the complex network, the number of digits of the processing time may be largely reduced.

Note that, for details of normal graph traversal, please refer to an appendix.

Also, in the first embodiment, a route that evidently does not satisfy the filter condition F is not added to the route set Q in Step S49. Accordingly, particularly, if the filter condition F is strict, many routes are excluded from search targets in accordance with the filter condition F, and therefore, the time taken to perform graph traversal may be reduced.

Despite that, in a complex network, a ratio of sparse portions is large, a performance problem does not occur depending on processing in the sparse portions, and therefore, it is not efficient to execute preprocessing on the entire complex network and generate an index. In this embodiment, grouping is executed only on a hub that is a cause of a performance problem and an efficient measure is realized.

Also, the method of this embodiment is also effective for a large-scale graph for which processing on a memory is difficult.

Processing of this embodiment will be described below using a specific example.

As a first example, a case in which the search condition is a condition: “a search target is a route in which a is a starting point and k is an end point” and the filter condition F is a condition: “the number of hops is 3 or less” will be described.

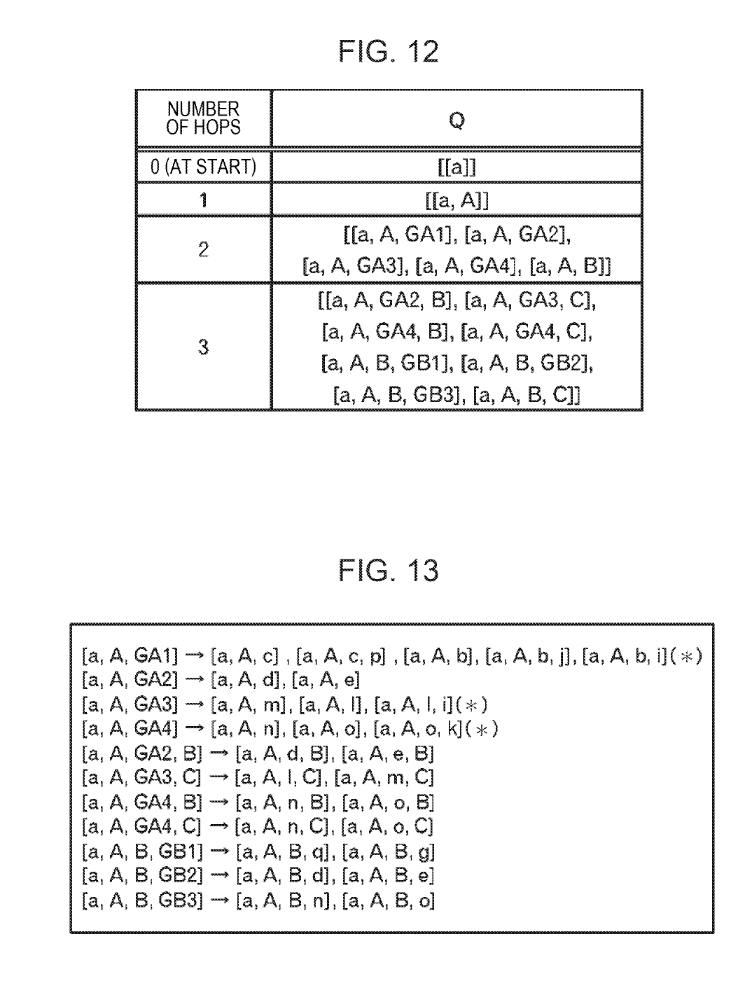

FIG. 12 is a table illustrating routes included in the route set Q for each number of hops.

A route [a] the number of hops of which is 0 is added to the route set Q. However, the route [a] evidently does not satisfy the search condition, and therefore, is not added to the route set R. A route [a, A] the number of hops of which is 1 is added to the route set Q. However, the route [a, A] evidently does not satisfy the search condition, and therefore, is not added to the route set R. A route [a, A, GA1], a route [a, A, GA2], a route [a, A, GA3], a route [a, A, GA4], and a route [a, A, B] the number of hops of each of which is 2 are added to the route set Q. Among these routes, the route [a, A, B] evidently does not satisfy the search condition, and therefore, the other routes than the route [a, A, B] are added to the route set R. A route [a, A, GA2, B], a route [a, A, GA3, C], a route [a, A, GA4, B], a route [a, A, GA4, C], a route [a, A, B, GB1], a route [a, A, B, GB2], a route [a, A, B, GB3], and a route [a, A, B, C] the number of hops of each of which is 3 are added to the route set Q. Among these routes, the route [a, A, B, C] evidently dose not satisfy the search condition, and therefore, the other routes than the route [a, A, B, C] are added to the route set R.

FIG. 13 is a view illustrating a result in a case in which expansion of a route including a group, among routes included in the route set Q and routes included in the route set R, has been executed. Note that, after expansion under a condition that the number of hops is 3 or less, search has been further executed.

When expansion of the group GA1 in the route [a, A, GA1] and search after expansion are executed, a route [a, A, c], a route [a, A, c, p], a route [a, A, b], a route [a, A, b, j], and a route [a, A, b, i] are acquired. When expansion of the group GA2 in the route [a, A, GA2] is executed, a route [a, A, d] and a route [a, A, e] are acquired. When expansion of the group GA3 in the route [a, A, GA3] and search after expansion are executed, a route [a, A, m], a route [a, A, I], and a route [a, A, I, i] are acquired. When expansion of the group GA4 in the route [a, A, GA4] and search after expansion are executed, a route [a, A, n], a route [a, A, o], and a route [a, A, o, k] are acquired.

When expansion of the group GA2 in the route [a, A, GA2, B] is executed, a route [a, A, d, B] and a route [a, A, e, B] are acquired. When expansion of the group GA3 in the route [a, A, GA3, C] is executed, a route [a, A, I, C] and a route [a, A, m, C] are acquired. When expansion of the group GA4 in the route [a, A, GA4, B] is executed, a route [a, A, n, B] and a route [a, A, o, B] are acquired. When expansion of the group GA4 in the route [a, A, GA4, C] is executed, a route [a, A, n, C] and a route [a, A, o, C] are acquired. When expansion of the group GB1 in the route [a, A, B, GB1] is executed, a route [a, A, B, q] and a route [a, A, B, g] are acquired. When expansion of the group GB2 in the route [a, A, B, GB2] is executed, a route [a, A, B, d] and a route [a, A, B, e] are acquired. When expansion of the group GB3 in the route [a, A, B, GB3] is executed, a route [a, A, B, n] and a route [a, A, B, o] are acquired.

Note that (*) indicates a route in which further search is possible because there is an adjacent vertex but processing has been terminated based on the filter condition F.

Based on the foregoing, as a route that satisfies the search condition and the filter condition F, the route [a, A, o, k] is acquired.

As a second example, a case in which the search condition is a condition: “a search target is a route in which a is a starting point and k is an end point” and the filter condition F is a condition: “the number of hops is 4 or less and a route does not go through a vertex B” will be described.

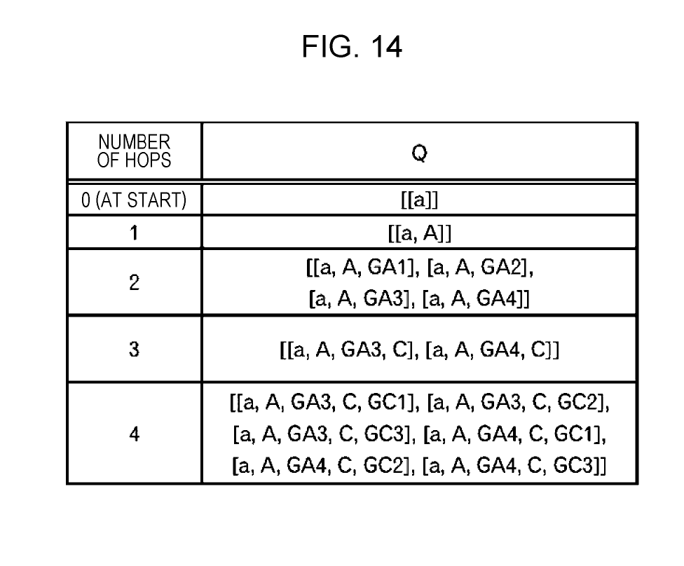

FIG. 14 is a table illustrating routes included in the route set Q for each number of hops.

A route [a] the number of hops of which is 0 is added to the route set Q. However, the route [a] evidently does not satisfy the search condition, and therefore, is not added to the route set R. A route [a, A] the number of hops of which is 1 is added to the route set Q. However, the route [a, A] evidently does not satisfy the search condition, and therefore, is not added to the route set R. A route [a, A, GA1], a route [a, A, GA2], a route [a, A, GA3], and a route [a, A, GA4] the number of hops of each of which is 2 are added to the route set Q. These routes are also added to the route set R. A route [a, A, GA3, C] and a route [a, A, GA4, C] the number of hops of each of which is 3 are added to the route set Q. These routes are also added to the route set R. A route [a, A, GA3, C, GC1], a route [a, A, GA3, C, GC2], a route [a, A, GA3, C, GC3], a route [a, A, GA4, C, GC1], a route [a, A, GA4, C, GC2], and a route [a, A, GA4, C, GC3] the number of hops of each of which is 4 are added to the route set Q. These routes are also added to the route set R.

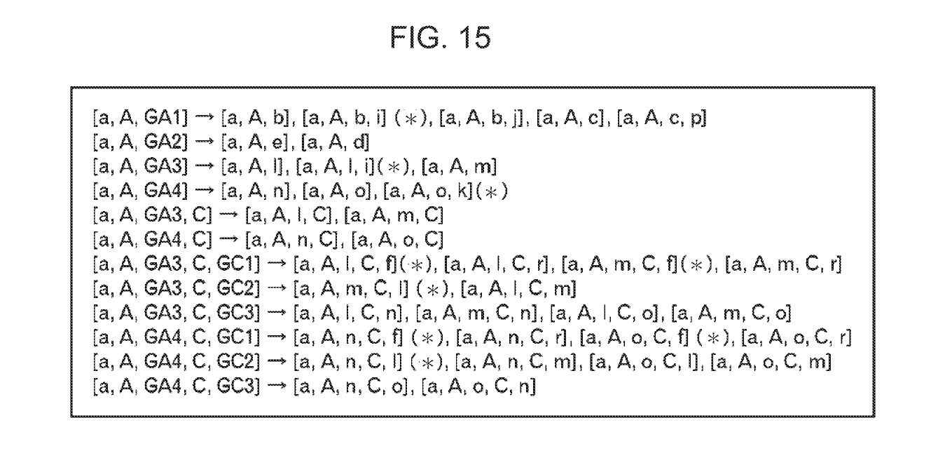

FIG. 15 is a view illustrating a result in a case in which expansion of a route including a group, among routes included in the route set Q and routes included in the route set R, has been executed. Note that, after expansion under a condition that the number of hops is 4 or less, search has been further executed.

When expansion of the group GA1 in the route [a, A, GA1] and search after expansion are executed, a route [a, A, c], a route [a, A, c, p], a route [a, A, b], a route [a, A, b, j], and a route [a, A, b, i] are acquired. When expansion of the group GA2 in the route [a, A, GA2] is executed, a route [a, A, d] and a route [a, A, e] are acquired. When expansion of the group GA3 in the route [a, A, GA3] and search after expansion are executed, a route [a, A, m], a route [a, A, I], and a route [a, A, I, i] are acquired. When expansion of the group GA4 in the route [a, A, GA4] and search after expansion are executed, a route [a, A, n], a route [a, A, o], and a route [a, A, o, k] are acquired.

When expansion of the group GA3 in the route [a, A, GA3, C] is executed, a route [a, A, I, C] and a route [a, A, m, C] are acquired. When expansion of the group GA4 in the route [a, A, GA4, C] is executed, a route [a, A, n, C] and a route [a, A, o, C] are acquired.

When expansion of the group GA3 and the group GC1 in the route [a, A, GA3, C, GC1] is executed, a route [a, A, I, C, f], a route [a, A, I, C, r], a route [a, A, m, C, f], and a route [a, A, m, C, r] are acquired. When expansion of the group GA3 and the group GC2 in the route [a, A, GA3, C, GC2] is executed, a route [a, A, m, C, I] and a route [a, A, I, C, m] are acquired. When expansion of the group GA3 in the route [a, A, GA3, C, GC3] is executed, a route [a, A, I, C, n], a route [a, A, m, C, n], a route [a, A, I, C, o], and a route [a, A, m, C, o] are acquired. When expansion of the group GA4 and the group GC1 in the route [a, A, GA4, C, GC1] is executed, a route [a, A, n, C, f], a route [a, A, n, C, r], a route [a, A, o, C, f], and a route [a, A, o, C, r] are acquired. When expansion of the group GA4 and the group GC2 in the route [a, A, GA4, C, GC2] is executed, a route [a, A, n, C, I], a route [a, A, n, C, m], a route [a, A, o, C, I], and a route [a, A, o, C, m] are acquired. When expansion of the group GA4 and the group GC3 in the route [a, A, GA4, C, GC3] is executed, a route [a, A, n, C, o] and a route [a, A, o, C, n] are acquired.

(*) is a route in which further search is possible because there is an adjacent vertex.

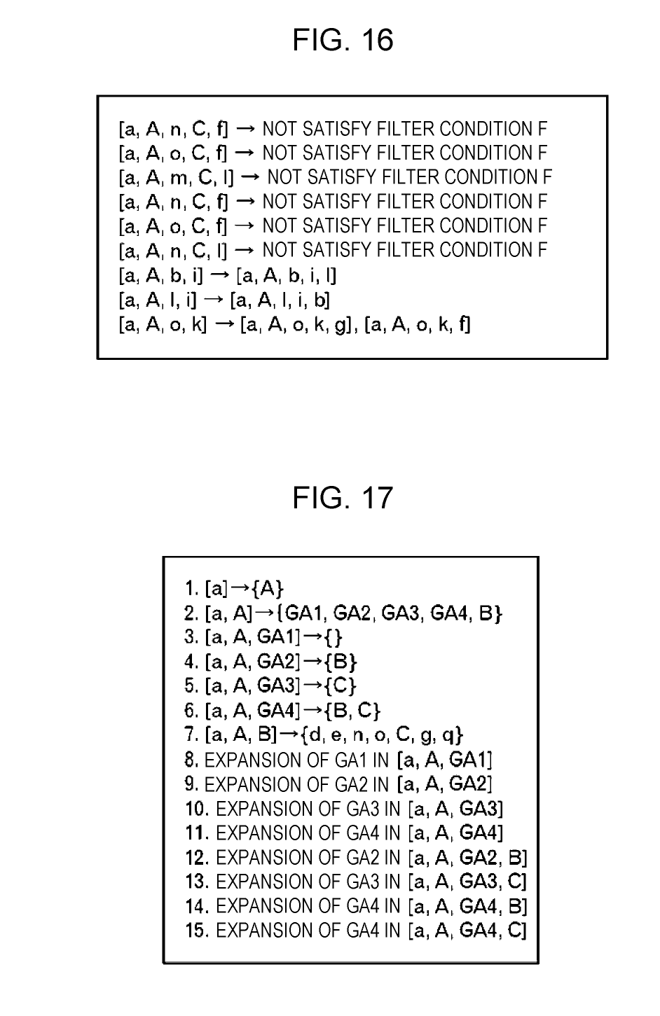

FIG. 16 is a view illustrating a result in a case in which further search has been executed for some of routes illustrated in FIG. 15. A route [a, A, n, C, f], a route [a, A, o, C, f], a route [a, A, m, C, l], a route [a, A, n, C, f], a route [a, A, o, C, f], and a route [a, A, n, C, I] do not satisfy the search condition.

A route [a, A, b, i, I] is acquired from a route [a, A, b, i]. A route [a, A, I, i, b] is acquired from a route [a, A, I, i]. A route [a, A, o, k, g] and a route [a, A, o, k, f] are acquired from a route [a, A, o, k].

Based on the foregoing, as a route that satisfies the search condition and the filter condition F, the route [a, A, o, k] is acquired.

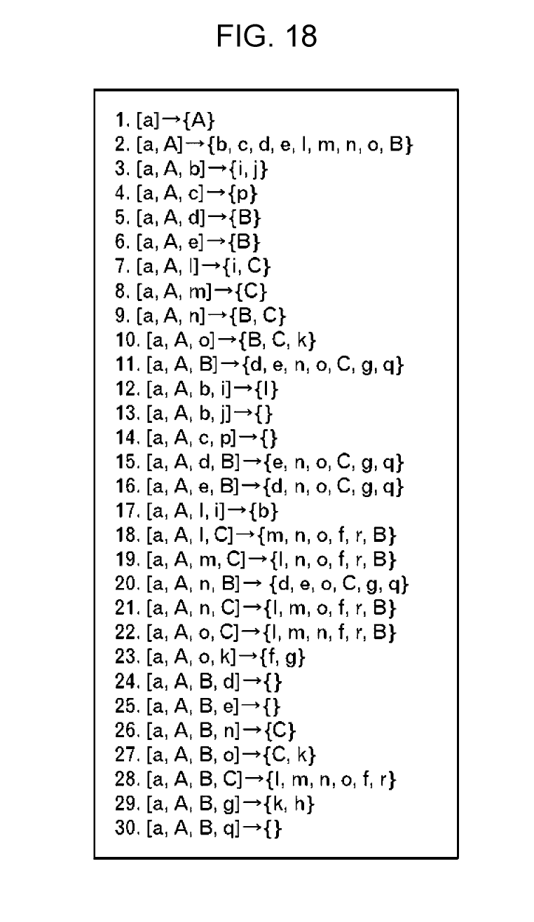

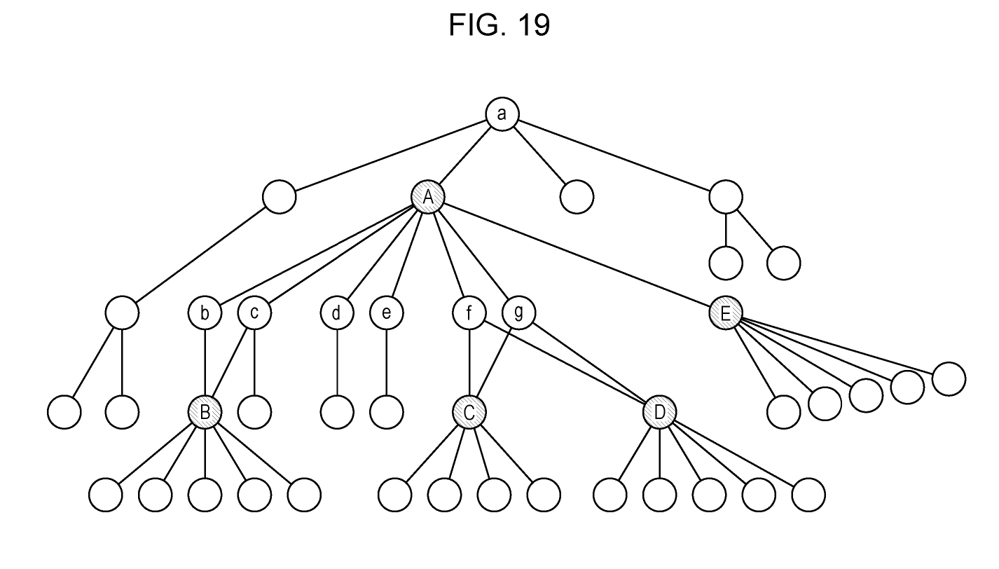

FIG. 17 is a view illustrating random access in a case in which graph traversal of this embodiment has been executed for the first example. For example, information in a first line indicates random access that is performed for identifying an adjacent vertex of a vertex a that is a last element in the route [a] from the first KVS 111. Also, for example, information in an eighth line indicates random access that is performed for identifying a vertex that belongs to the group GA1 that is a last element in the route [a, A, GA1] from the second KVS 113. As described above, random access of 15 times in total occurs. On the other hand, FIG. 18 is a view illustrating random access in a case in which normal graph traversal has been executed for the first example. As described above, random access of 30 times in total occur.

As described above, when graph traversal of this embodiment is executed, the number of times of ransom access may be reduced, and therefore, time until graph traversal is eventually completed may be reduced.

Note that the method of this embodiment is applicable not only to the non-directed graphs illustrated in FIG. 3 to FIG. 6 but also to, for example, a directed graph illustrated in FIG. 19 in which a certain vertex (a vertex a in FIG. 19) is a starting point. In FIG. 19, a vertex the number of edges of which is 4 or more is a hub and hubs are a vertex A, a vertex B, a vertex C, a vertex D, and a vertex E. The vertex a, a vertex b, a vertex c, a vertex d, a vertex e, a vertex f, a vertex g, and the vertex E are coupled to the hub A.

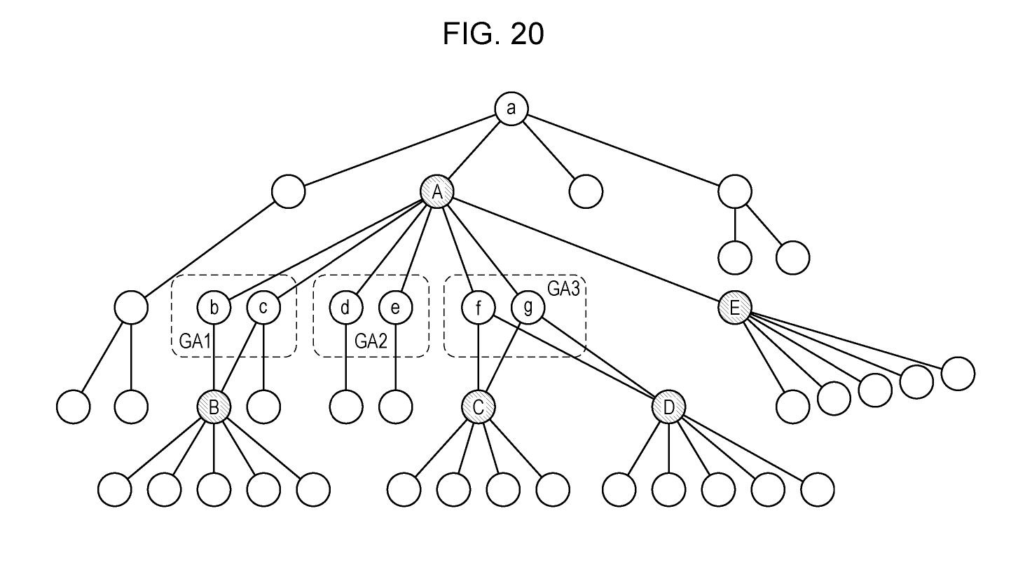

In the above-described case, for example, grouping is executed as illustrated in FIG. 20. In an example of FIG. 20, a vertex b and a vertex c coupled to a hub A and a hub B belong to a group GA1, a vertex d and a vertex e coupled only to the hub A belong to a group GA2, a vertex f and a vertex g coupled to the hub A, a hub C, and a hub D belong to a group GA3, and a hub E does not belong to any group.

### Second Embodiment

In the first embodiment, routes that do not satisfy the filter condition F are collectively removed after route search has been completed. In contrast, in a second embodiment, a route that does not satisfy the filter condition F is removed during route search. Therefore, depending on a form of the complex network and contents of the filter condition F, the time taken to perform graph traversal is further reduced.

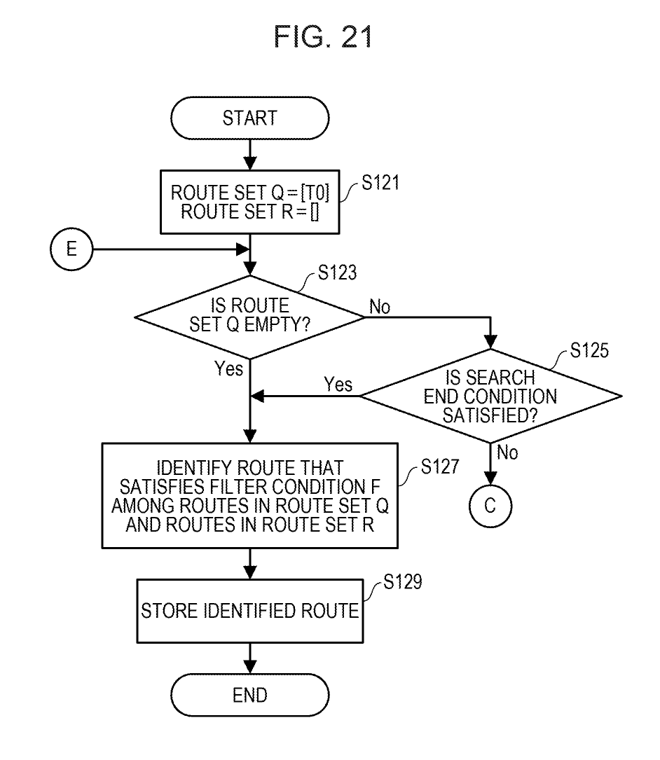

FIG. 21 is a flowchart illustrating a processing flow of processing that is executed by a traversal processing unit 105 of the second embodiment. This processing is executed when a traversal query is received or accepted.

The traversal processing unit 105 executes initialization for traversal processing. Specifically, the traversal processing unit 105 sets a route set Q to Q=[T0] and sets a route set R to R=[ ] (Step S121 in FIG. 21).

In this embodiment, a route of graph traversal is expressed by a list. For example, when a vertex a, a vertex b, and a vertex c are searched in this order, a route is expressed as [a, b, c]. Q is a queue that is temporarily used and R is a queue that is used for storing a result.

It is assumed that a vertex that is a starting point of graph traversal is n0. It is assumed that a route including only n0 is T0. That is, T0=[n0].

The traversal processing unit 105 determines whether or not the route set Q is empty (Step S123).

If the route set Q is empty (YES route in Step S123), the process proceeds to Step S127. On the other hand, if the route set Q is not empty (NO route in Step S123), the traversal processing unit 105 determines whether or not a search end condition is satisfied (Step S125). The search end condition is included in a traversal query and is a condition in which routes of a predetermined number or more have been found, a condition in which the number of hops of graph traversal has exceeded a predetermined threshold, or the like.

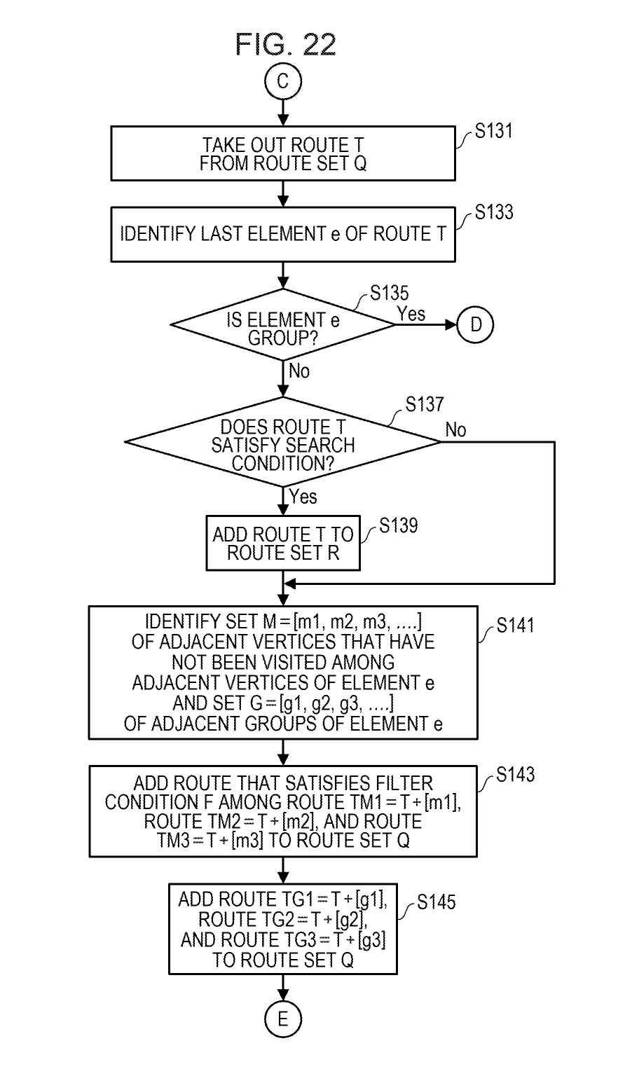

If the search end condition is not satisfied (NO route in Step S125), the process proceeds to processing in Step S131 in FIG. 22.

Moving to description of FIG. 22, the traversal processing unit 105 takes out one of routes in the route set Q (Step S131 in FIG. 22). A route that has been taken out in Step S131 will be hereinafter called a route T.

The traversal processing unit 105 identifies a last element of the route T (Step S133). An element that has been identified in Step S133 will be hereinafter called element e. The element e is a vertex or a group. For example, if the route T is [A, B, c], the element e is the vertex c.

The traversal processing unit 105 determines whether or not the element e that has been identified in Step S133 is a group (Step S135).

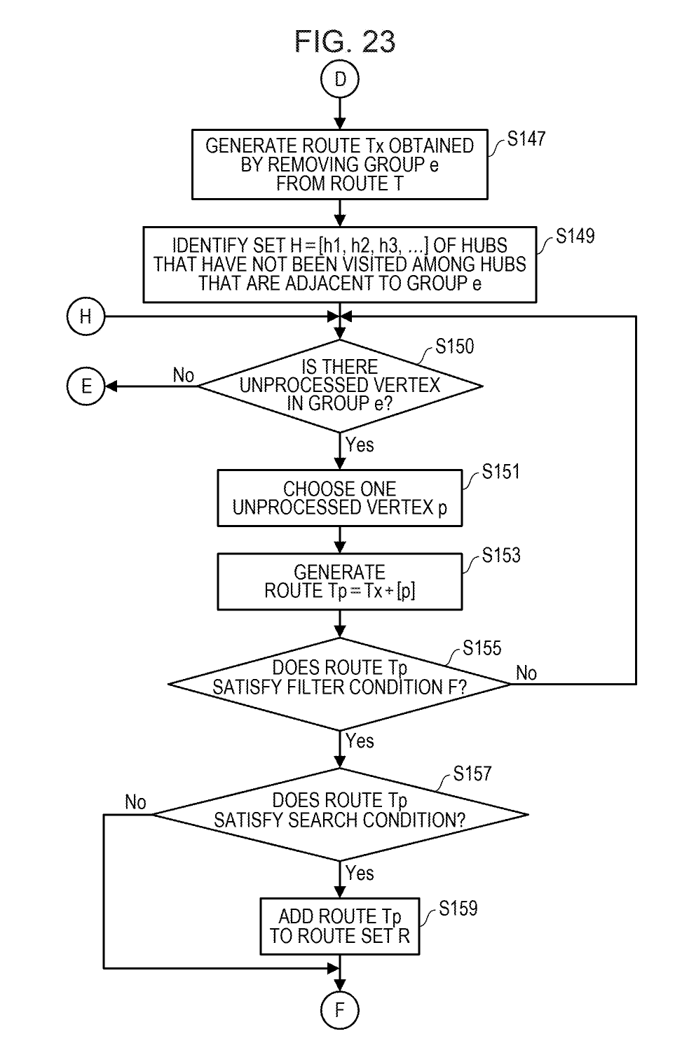

If the element e is a group (YES route in Step S135), the process proceeds to Step S147 in FIG. 23.

On the other hand, if the element e is not a group (NO route in Step S135), the traversal processing unit 105 determines whether or not the route T satisfies a search condition (Step S137). The search condition is included in a traversal query and is, for example, a condition: a search target is a route in which a vertex a is a starting point and a vertex k is an end point or the like.

If the route T does not satisfy the search condition (NO route in Step S137), the process proceeds to Step S141. On the other hand, if the route T satisfies the search condition (YES route in Step S137), the traversal processing unit 105 adds the route T to the route set R (Step S139).

The traversal processing unit 105 identifies a set M=[m1, m2, m3, . . . ] of adjacent vertices that have not been visited among adjacent vertices of the element e and a set G=[g1, g2, g3, . . . ] of adjacent groups of the element e, based on data stored in the first KVS 111 and data stored in second KVS 113 (Step S141). A vertex which has not been visited herein means a vertex that is not included in the route T. Similar applies to description below.

The traversal processing unit 105 generates a route TM1=T+[m1], a route TM2=T+[m2], a route TM3=T+[m3], . . . . Then, the traversal processing unit 105 adds a route that satisfies the filter condition F among the route TM1, the route TM2, the route TM3, . . . to the route set Q (Step S143). The filter condition F is included in the traversal query and is, for example, a condition in which the number of hops is a predetermined number or less, a condition in which the route goes through a certain vertex, or the like.

The traversal processing unit 105 generates a route TG1=T+[g1], a route TG2=T+[g2], a route TG3=T+[g3], . . . . Then, the traversal processing unit 105 adds the route TG1, the route TG2, the route TMG3, . . . to the route set Q (Step S145). However, if G is an empty set, processing of Step S145 is skipped. Then, the process returns to Step S123 in FIG. 21.

Moving to description of FIG. 23, the traversal processing unit 105 generates a route Tx that is a route obtained by removing the group e from the route T (Step S147 in FIG. 23).

The traversal processing unit 105 identifies a set H=[h1, h2, h3 . . . ] of hubs that have not been visited among hubs that are adjacent to the group e, based on data stored in the second KVS 113 (Step S149). As has been described above, vertices that belong to the same group are coupled to the same hub. In Step S149, hubs that are adjacent to vertices in a group are collectively identified by one random access, and therefore, random access may not be performed for each vertex. Thus, the number of times of random access may be reduced and the time taken to perform graph traversal may be reduced.

The traversal processing unit 105 determines whether or not there is an unprocessed vertex in the group e (Step S150). If there is not an unprocessed vertex (NO route in Step S150), the process returns to Step S123 in FIG. 21.

On the other hand, if there is an unprocessed vertex (YES route in Step S150), the traversal processing unit 105 chooses one unprocessed vertex among vertices that belong to the group e (Step S151). A vertex that has been chosen in Step S151 will be hereinafter called a vertex p.

The traversal processing unit 105 generates a route Tp=Tx+[p] (Step S153). For example, when Tx=[a, b], Tp=[a, b, p].

The traversal processing unit 105 determines whether or not a route Tp satisfies the filter condition F (Step S155).

If the route Tp does not satisfy the filter condition F (NO route in Step S155), the process returns to Step S150. On the other hand, if the route Tp satisfies the filter condition F (YES route in Step S155), the traversal processing unit 105 determines whether or not the route Tp satisfies the search condition (Step S157).

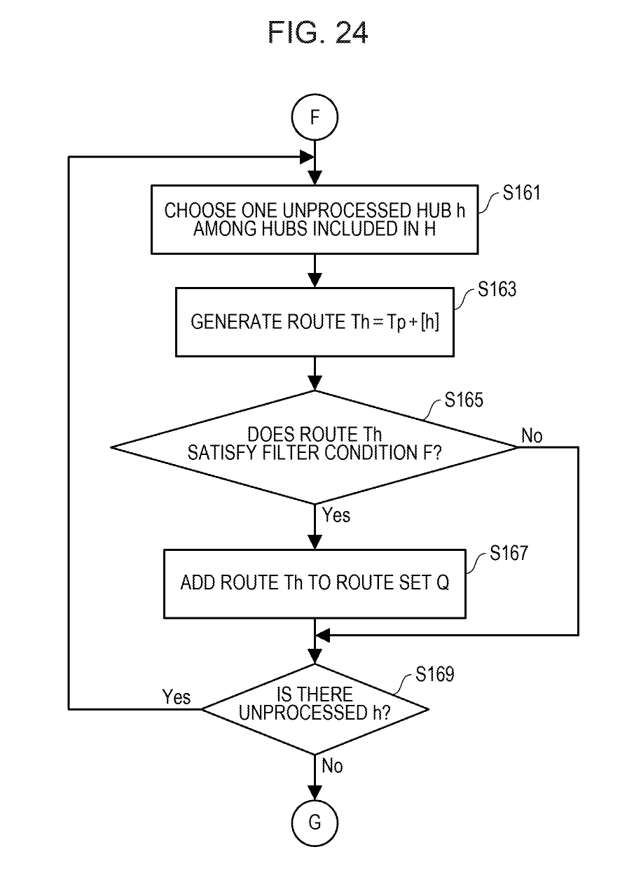

If the route Tp does not satisfy the search condition (NO route in Step S157), the process proceeds to Step S161 in FIG. 24. On the other hand, if the route Tp satisfies the search condition (YES in Step S157), the route Tp is added to the route set R (Step S159). Then, the process proceeds to Step S161 in FIG. 24.

Moving to description of FIG. 24, the traversal processing unit 105 chooses one unprocessed hub among hubs included in the set H of hubs (Step S161 in FIG. 24). A hub that has been chosen in Step S161 will be hereinafter called a hub h.

The traversal processing unit 105 generates a route Th=Tp+[h] (Step S163).

The traversal processing unit 105 determines whether or not the route Th satisfies the filter condition F (Step S165).

If the route Th does not satisfy the filter condition F (NO route in Step S165), the process proceeds to Step S169. On the other hand, if the route Th satisfies the filter condition F (YES route in Step S165), the traversal processing unit 105 adds the route Th to the route set Q (Step S167).

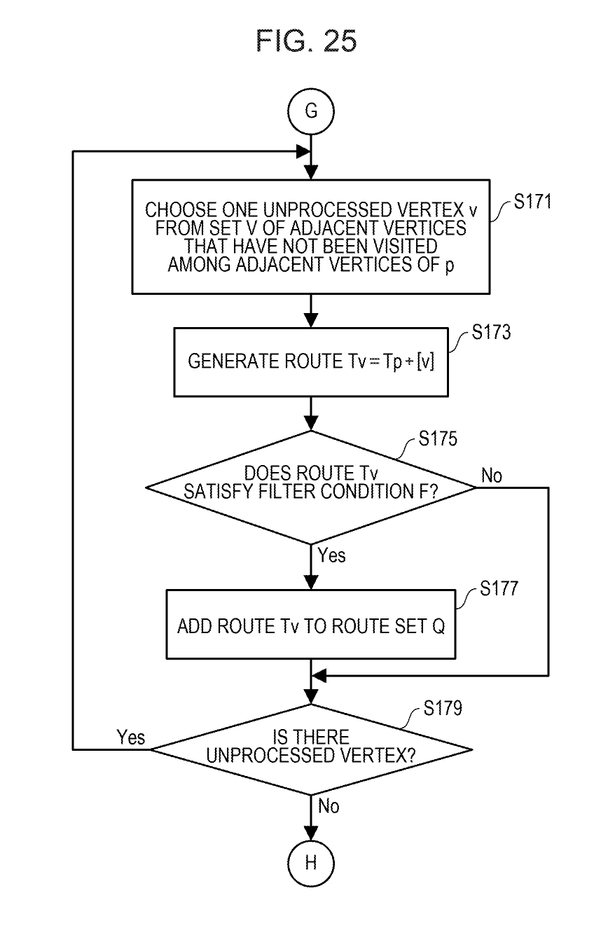

The traversal processing unit 105 determines whether or not there is an unprocessed hub among hubs included in the set H of hubs (Step S169). If there is an unprocessed hub (YES route in Step S169), the process returns to Step S161. On the other hand, if there is not an unprocessed hub (NO route in Step S169), the process proceeds to Step S171 in FIG. 25.

Moving to description of FIG. 25, the traversal processing unit 105 chooses one unprocessed vertex from a set V of adjacent vertices that have not been visited among adjacent vertices (in this case, other vertices than a hub) of the vertex p, based on data stored in the first KVS 111. A vertex that has been chosen in Step S171 will be hereinafter called a vertex v.

The traversal processing unit 105 generates a route Tv=Tp+[v] (Step S173).

The traversal processing unit 105 determines whether or not the route Tv satisfies the filter condition F (Step S175).

If the route Tv does not satisfy the filter condition F (NO route in Step S175), the process proceeds to Step S179. On the other hand, if the route Tv satisfies the filter condition F (YES route in Step S17), the traversal processing unit 105 adds the route Tv to the route set Q (Step S177).

The traversal processing unit 105 determines whether or not there is an unprocessed vertex (Step S179).

If there is an unprocessed vertex (YES route in Step S179), the process returns to Step S171. On the other hand, if there is not an unprocessed vertex (NO route in Step S179), the process returns to Step S150.

Returning to description of FIG. 21, if the search end condition is satisfied (YES route in Step S125), the traversal processing unit 105 identifies a route that satisfies the filter condition F among routes in the route set Q and routes in the route set R (Step S127).

The traversal processing unit 105 stores information (for example, information in which identification information of a vertex included in a route is arranged in order) of a route that has been identified in Step S127 in the output data storage unit 115 (Step S129). Then, the process ends. Note that the traversal processing unit 105 may be configured to output information of the route stored in the output data storage unit 115 (for example, display the information on a display unit or transmit the information to a transmission source of a traversal query).

Normal graph traversal has a feature that the number of vertices that are searched and the number of times of random access substantially match. In contrast, in the method of this embodiment, vertices are classified into groups, based on a hub and one random access is executed on a plurality of vertices. Thus, even when a route goes through a hub, it is possible to restrain increase of the processing time caused by increase of the number of times of random access. Depending on the complex network, the number of digits of the processing time may be largely reduced.

Also, in the second embodiment, a route that does not satisfy the filter condition F is not added to the route set Q in Step S143. Accordingly, particularly, when the filter condition F is strict, many routes are excluded from search targets in accordance with the filter condition F, and therefore, the time taken to perform graph traversal may be reduced.

Despite that, in a complex network, a ratio of sparse portions is large, a performance problem does not occur depending on processing in the sparse portions, and therefore, it is not efficient to execute preprocessing on the entire complex network and generate an index. In this embodiment, grouping is executed only on hubs that are a cause of a performance problem and an efficient measure is realized.

Also, the method of this embodiment is also effective for a large-scale graph for which processing on a memory is difficult.

Although embodiments of the present disclosure have been described above, the present disclosure is not limited to the above-described embodiments. For example, in some cases, the above-described functional block configuration of the information processing device 1 does not match an actual program module configuration.

Also, a configuration of each table described above is an example, and each table may not have the above-described configuration. Furthermore, in the process flows, if the process result is not changed, a procedural sequence of the process may be changed. Furthermore, the processes may be performed in parallel.

For example, the processing time may be reduced by executing graph traversal and expansion in parallel.

[Appendix]

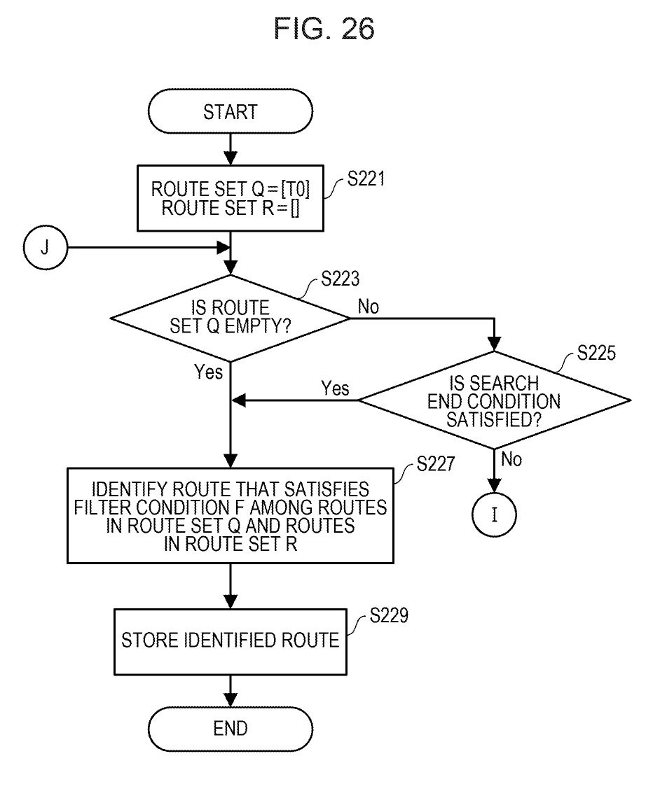

In this appendix, processing that is executed in normal graph traversal will be described. FIG. 26 is a flowchart illustrating a processing flow of processing that is executed in normal traversal processing.

The traversal processing unit 105 executes initialization for traversal processing. Specifically, the traversal processing unit 105 sets a route set Q to Q=[T0] and a route set R to R=[ ] (Step S221 in FIG. 26).

The traversal processing unit 105 determines whether or not the route set Q is empty (Step S223).

If the route set Q is empty (YES route in Step S223), the process proceeds to Step S227. On the other hand, if the route set Q is not empty (NO route in Step S223), the traversal processing unit 105 determines whether or not a search end condition is satisfied (Step S225).

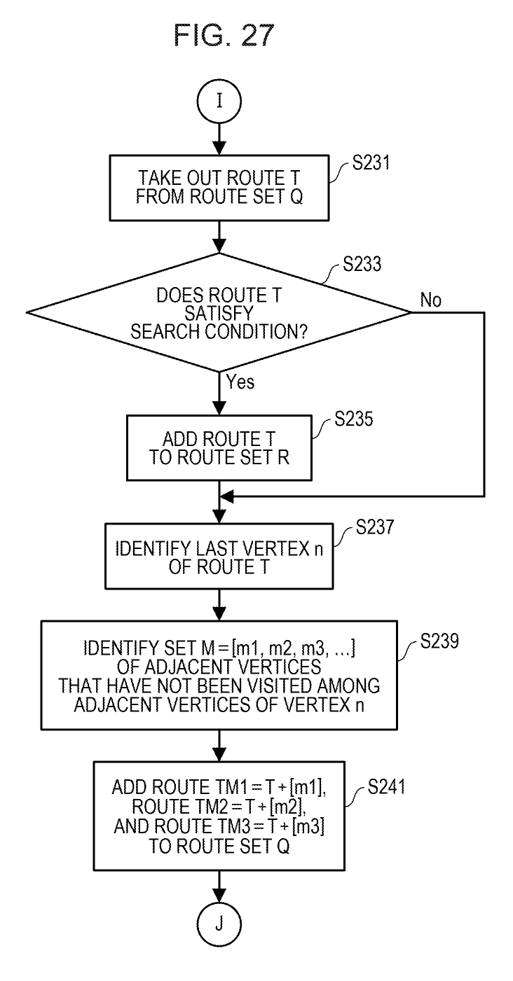

If the search end condition is not satisfied (NO route in Step S225), the process proceeds to processing in Step S231 in FIG. 27.

Moving to description of FIG. 27, the traversal processing unit 105 takes out one of routes in the route set Q (Step S231 in FIG. 27). A route that has been taken out in Step S231 will be hereinafter called a route T.

The traversal processing unit 105 determines whether or not the route T satisfies a search condition (Step S233). The search condition is included in a traversal query and is, for example, a condition in which a search target is a route in which a vertex a is a starting point and a vertex k is an end point or the like.

If the route T does not satisfy the search condition (NO route in Step S233), the process proceeds to Step S237.

On the other hand, if the route T satisfies the search condition (YES route in Step S233), the traversal processing unit 105 adds the route T to the route set R (Step S235).

The traversal processing unit 105 identifies a vertex n that is a last vertex of the route T (Step S237).

The traversal processing unit 105 identifies an adjacent vertex of the vertex n, based on data stored in the first KVS 111. Then, the traversal processing unit 105 identifies a set M=[m1, m2, m3, . . . ] of unprocessed adjacent vertices among adjacent vertices of the vertex n (Step S239).

The traversal processing unit 105 generates a route TM1=T+[m1], a route TM2=T+[m2], a route TM3=T+[m3], . . . . Then, the traversal processing unit 105 adds the route TM1, the route TM2, the route TM3, . . . to the route set Q (Step S241). Then, the process returns to Step S223 in FIG. 26.

Returning to description of FIG. 26, if the search end condition is satisfied (YES route in Step S225), the traversal processing unit 105 identifies a route that satisfies the filter condition F among routes in the route set Q and routes in the route set R (Step S227).

The traversal processing unit 105 stores information (for example, information in which identification information of a vertex included in a route is arranged in order) of a route that has been identified in Step S227 in the output data storage unit 115 (Step S229). Then, the process ends. Note that the traversal processing unit 105 may be configured to output information of the route stored in the output data storage unit 115 (for example, display the information on a display unit or transmit the information to a transmission source of a traversal query).

As described above, normal graph traversal is caused to progress by repeatedly referring to the first KVS 111 in which a vertex is a key and an adjacent vertex is a value.

Note that, although an example of graph traversal based on simple breadth first search has been described herein, there are many variations of graph traversal, such as, for example, graph traversal based on depth first search, graph traversal in which a vertex that has been visited is not visited again, or the like.

The appendix is thus concluded.

Note that the information processing device 1 described above is a computer device and, as illustrated in FIG. 28, a memory 2501, a CPU 2503, a solid state drive 2505, a display control unit 2507 coupled to a display device 2509, a drive unit 2513 for a removal disk 2511, an input device 2515, and a communication control unit 2517 that provides a connection to a network are coupled to the information processing device 1 via a bus 2519. An application program that is used for performing processing in an operating system (OS) and the above-described embodiments is stored in the SSD 2505 and, when the application program is executed by the CPU 2503, is read out from the SSD 2505 to the memory 2501. The CPU 2503 controls the display control unit 2507, the communication control unit 2517, and the drive unit 2513 in accordance with processing contents of the application program and causes each of the display control unit 2507, the communication control unit 2517, and the drive unit 2513 to perform a predetermined operation. Also, data in processing is stored mainly in the memory 2501 but may be stored in the SSD 2505. In an embodiment of the present disclosure, the application program that is used for performing the processing described above is stored in a computer-readable removal disk 2511, is distributed, and is installed from the 2513 to the SSD 2505. In some cases, the application program is installed in the SSD 2505 via a network, such as the Internet or the like, and the communication control unit 2517. Hardware, such as the CPU 2503, the memory 2501, or the like, described above, the OS, and a program, such as an application program or the like, organically cooperate with one another, and thereby, the computer device realizes each of various functions described above.

The above-described embodiments of the present disclosure are summarized as follows.

An information processing device according to a first aspect of the embodiments includes (A) a grouping unit (the grouping unit 103 in the embodiments described above is an example of the grouping unit) that extracts a hub that is a vertex having edges of a predetermined number or more from a complex network, classifies vertices that are adjacent to the extracted hub into groups, and stores group information including identification information of a plurality of vertices that belong to a group and identification information of vertices that are adjacent to the plurality of vertices in association with identification information of the group in a storage unit (the second WS 113 in the embodiments described above is an example of the storage unit) and (B) a traversal processing unit (the traversal processing unit 105 in the embodiments described above is an example of the traversal processing unit) that identifies, in graph traversal of the complex network, vertices that are adjacent to a plurality of vertices that belong to each group from the storage unit, using the identification information of the group as a key, and expands a group on a route that is generated by graph traversal, based on group information of the group, to generate a plurality of routes.

In graph traversal of a complex network, a hub having many edges causes increase of the number of times of random access to increase processing time. Therefore, when the processing described above is executed, random access is performed by a group unit, not by a vertex unit, and therefore, the time taken to perform graph traversal on the complex network may be reduced.

Also, the above-described grouping unit may be configured to (al) execute, if a plurality of hubs has been extracted, grouping such that vertices to which hubs in the same combination are adjacent belong to the same group.

Grouping may be performed such that the number of times of random access is reduced.

The above-described predetermined number may be a number that is determined based on time taken to perform one random access to the storage unit and processing time allowable for each vertex, or the predetermined number may be a number of edges at a predetermined rank in descending order of number of edges of vertices in the complex network.

A hub that causes increase of the processing time may be appropriately extracted.

Also, the above-described traversal processing unit may be configured to (b1) expand a group on a route that is generated by graph traversal after the generation of the route has been completed and identify a route that satisfies a predetermined condition among a plurality of generated routes.

Expansion may be collectively executed.

Also, the above-described traversal processing unit may be configured to (b2) expand, if, during generation of a route by graph traversal, a group has been detected on the route, the group and execute graph traversal along a route that satisfies a predetermined condition among routes that have been generated by expansion to generate a plurality of routes.

A route that does not satisfy a predetermined condition may be removed in the middle of processing.

Also, the above-described predetermined condition may be included in a query of graph traversal.

An information processing method according to a second aspect of the embodiments includes (C) extracting a hub that is a vertex having edges of a predetermined number or more from a complex network, (D) classifying vertices that are adjacent to the extracted hub into groups, (E) storing group information including identification information of a plurality of vertices that belong to a group and identification information of vertices that are adjacent to the plurality of vertices in association with identification information of the group in a storage unit, (F) identifying, in graph traversal of the complex network, vertices that are adjacent to a plurality of vertices that belong to each group from the storage unit, using the identification information of the group as a key, and (G) expanding a group on a route that is generated by graph traversal, based on group information of the group, to generate a plurality of routes.

Note that a program used for causing a computer to execute processing by the above-described method may be generated and the program is stored in a computer-readable storage medium or a semiconductor device, such as, for example, a flexible disk, a CD-ROM, a magnetooptical disk, a semiconductor memory, a hard disk, or the like. Note that an intermediate processing result is temporarily stored in a storage device, such as a main memory or the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a memory configured to store node information regarding a plurality of nodes included in a network; and
a processor coupled to the memory and the processor configured to:
extract at least one hub node from the network based on the node information stored in the memory, the at least one hub node being a node connected to a predetermined number of nodes or more in the network;
classify nodes connected to each of the at least one hub node into groups;
store group information for each of the groups in the memory in association with identification information of the group, the group information including identification information of each member node that belongs to the group and identification information of each adjacent node connected to each member node;
generate, in graph traversal of the network, a route by identifying each adjacent node for each group by using the identification information of the group as a key from the group information stored in the memory; and
generate a plurality of routes by expanding a first group on the route generated by the graph traversal, based on group information of the first group.

2. The information processing device according to claim 1, wherein
the processor is further configured to execute, when the at least one hub node includes a plurality of hub nodes, the classification such that each of the groups includes member nodes sharing same one or more hub nodes connected to the member nodes.

3. The information processing device according to claim 1, wherein
the predetermined number is a number determined based on time taken to perform one random access to the memory and processing time allowable for each node, or the predetermined number is a number of nodes connected to a node that is at a predetermined rank in descending order of a number of nodes connected to each node in the network.

4. The information processing device according to claim 1, wherein
the processor is further configured to:
expand the first group after the generation of the plurality of routes has been completed;
identify a route that satisfies a predetermined condition among the plurality of routes; and
output information regarding the identified route.

5. The information processing device according to claim 1, wherein
the processor is further configured to:
detect the first group on the route during generation of the route by the graph traversal;
expand the first group upon detection of the first group; and
generate the plurality of routes by executing the graph traversal along a route that satisfies a predetermined condition among routes that have been generated by the expansion.

6. The information processing device according to claim 4, wherein
the predetermined condition is included in a query of the graph traversal.

7. A non-transitory computer-readable recording medium having stored therein a program that causes a computer to execute a process, the process comprising:
extracting at least one hub node from a network based on node information regarding a plurality of nodes included in the network, the at least one hub node being a node connected to a predetermined number of nodes or more in the network;
classifying nodes connected to each of the at least one hub node into groups;
storing group information for each of the groups in the memory in association with identification information of the group, the group information including identification information of each member node that belongs to the group and identification information of each adjacent node connected to each member node;
generating, in graph traversal of the network, a route by identifying each adjacent node for each group by using the identification information of the group as a key from the group information stored in the memory; and
generating a plurality of routes by expanding a first group on the route generated by the graph traversal, based on group information of the first group.

8. A computer-implemented method for management of a network, the method comprising:
storing, in a memory, node information regarding a plurality of nodes included in the network;
extracting, by a computer, at least one hub node from the network based on the node information stored in the memory, the at least one hub node being a node connected to a predetermined number of nodes or more in the network;
classifying nodes connected to each of the at least one hub node into groups, each of the groups including member nodes sharing same one or more hub nodes connected to the member nodes;
storing group information for each of the groups in the memory in association with identification information of the group, the group information including identification information of each member node that belongs to the group and identification information of each adjacent node connected to each member node;
receiving a traversal query with a search condition for searching the network;
generating, in graph traversal of the network in accordance with the traversal query, a route by identifying each adjacent node for each group by using the identification information of the group as a key from the group information stored in the memory;
generating a plurality of routes by expanding a first group on the route generated by the graph traversal, based on group information of the first group;
identifying a route that satisfies the search condition from the generated plurality of routes; and
outputting information regarding the identified route.

9. The computer-implemented method according to claim 8, wherein the group information collectively identifies all nodes in each of the groups and is obtained with a single random access.
